(19) United States
(12) Patent Application Publication
(10) Pub. No.: US 2024/0025533 A1
(43) Pub. Date: Jan. 25, 2024

(54) AUTOMATED GENERATION OF RULES AND CONTROL FROM PARTIAL RULESETS

(71) Applicant: OptumSoft, Inc., Vero Beach, FL (US)

(72) Inventor: David R. Cheriton, Vero Beach, FL (US)

(21) Appl. No.: 18/225,627

(22) Filed: Jul. 24, 2023

Related U.S. Application Data
(60) Provisional application No. 63/392,057, filed on Jul. 25, 2022.

(51) Int. Cl. B64C 13/00; G05D 1/08

(52) U.S. Cl. CPC B64C 13/00; G05D 1/0808

(57) ABSTRACT

A system is controlled. A ruleset is specified based at least in part on a ruleset expression that comprises one or more ruleset operations whose operands include partial rulesets. The ruleset expression is evaluated to produce a compiled ruleset. The compiled ruleset is outputted. The outputted compiled ruleset is applied to control a physical actuator.

### CROSS REFERENCE TO OTHER APPLICATIONS

This application claims priority to U.S. Provisional Patent Application No. 63/392,057 entitled AUTOMATED GENERATION OF RULES FROM PARTIAL RULE SETS filed Jul. 25, 2022 which is incorporated herein by reference for all purposes.

### BACKGROUND OF THE INVENTION

Engineered systems such as autonomous vehicles, including self-driving automobiles and self-piloting airplanes, currently require a significant amount of human control. Safety and efficiency of such human control may be improved with increased computer-based decision making and control.

### BRIEF DESCRIPTION OF THE DRAWINGS

Various embodiments of the invention are disclosed in the following detailed description and the accompanying drawings.

FIG. 1 is a functional diagram illustrating a programmed computer/server system for automated generation of rules and control in accordance with some embodiments.

FIG. 2 is a block diagram illustrating an embodiment of a rule-based control system.

FIG. 3 is an illustration of an application ruleset being computed as an expression in terms of ruleset operations and partial rulesets as operands.

FIG. 4 is an illustration of an embodiment of processing of a ruleset compiler.

FIG. 5 is an illustration of a rule as a mapping from the rule condition set to the rule action set.

FIG. 6 is an illustration of a representation of rules in a table using identified subconditions that, as a conjunction, represent the rule condition.

FIG. 7 is an illustration of hierarchical classification using indirect reference to partial rulesets.

FIG. 8 is an illustration of the result of automatically computing a discretized partial ruleset for the trade-off between air-speed and altitude.

FIG. 9 is a flow diagram illustrating an embodiment of a process for automated generation of a ruleset and control.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Rule-based decision making is an improved way to structure computer-based decision making and control in complex applications. For example, autonomous aircraft may be controlled by a ruleset, deciding based on one or more inputs, such as one or more physical sensors, the next action to take. However, specifying and evolving an appropriate complex ruleset that is complete, unambiguous, and correct may be challenging.

For example, a ruleset may be incomplete because no rule matches in a possible input scenario, as characterized by the inputs to the ruleset. For example, in a civilian airplane, an autonomous aircraft ruleset may not have a rule to match when the possible input scenario includes detecting a military missile.

For example, a ruleset may be ambiguous/conflicting because two rules with different actions may match a given input scenario, making it unclear how to act. For example, in an autonomous aircraft ruleset there may be a first rule based on weather events in order to control an elevator actuator to climb, and a second rule based on a passenger emergency to control an elevator actuator to dive. When an input scenario includes a passenger emergency resulting from inclement weather, it may be unclear on whether to climb or dive.

For example, it is difficult to determine that all rules are correct, given the correctness may entail different aspects of operation. That is, different experts may need to examine a rule for correctness, even though their area of expertise extends to a portion of the rule condition. For example, a regulatory expert may know the regulations that need to be followed by an aircraft but not the conditions relevant to maintain stable flight.

A rule condition portion of an application rule is challenging to specify. This is because the action or decision result of each rule may need knowledge outside of the rule-based decision mechanism and is often pre-specified by the controlled system. This in turn may be needed because this action or result indication is provided as output to the rest of the system to act on. For example, with an aircraft, there are actions to increase or decrease the throttle, raise and lower the elevator, and so on which are all relatively simple actions, but it is the deciding on these actions that is challenging. Similarly, with a self-driving automobile, the actions are in essence steering the wheels, accelerating, and braking. In general, the set of possible application actions associated rules is known, as is how to carry out each such action.

There are different aspects to consider with regards to an application rule condition. For example, to perform a particular aircraft maneuver, one aspect is the engineering manual specification of requirements for the maneuver, that is airspeed and altitude and control surface positioning. Another is the presence of other traffic in the vicinity. Incorporating each aspect directly into the rule condition for each application rule is complicated and/or duplicative and therefore hard to get correct and hard to maintain over time, with the need to refine and extend the ruleset over time and/or evolve. Also, there are preconditions to an action and postconditions corresponding to a scenario that is expected after the action is taken, possibly as a result of the expected changes in the environment, not just the changes in the controlled system. For example, a climb action may put the autonomous aircraft at an altitude that is still not reasonably clear of conflicting traffic. In general, there are many aspects to include in the application rule condition in a real application.

Furthermore, some rules are commonly stated as prohibitive rules, that is if the condition is met then the specified action is not allowed. A prohibitive rule needs to be incorporated into a constructive ruleset so that an action is not performed under a scenario for which it is prohibited. Requiring that a prohibitive rule be translated manually to a constructive rule increases the cost and error-proneness of developing and maintaining an adequate ruleset.

There may be subconditions of rules that occur in several of the rules yet narrowed in different usages. This leads to duplication that is not exact but similar and so hard to maintain and/or evolve. In particular, a simple definition of each subcondition and reference in each such rule is not feasible.

Completely automating the generation of rules is attractive to reduce the human time involved but may be impractical for some complex applications. The input combinations may number in the trillions and the need to evaluate using simulation over a sufficient period of time adds to the impracticality.

In some cases, portions of a rule condition may be computed and thus generated automatically. For example, there is the trade-off between airspeed and altitude for achieving cruising posture. That is, the higher the altitude is (within limits), the lower the airspeed can be in order to safely perform a given maneuver. This computation may need to recognize boundary conditions, for example, no airspeed can make up for altitude below some level. However, it is not clear how to incorporate the result of an automatic computation of one aspect of a rule condition into manually specified rules except by calling a procedure as part of rule evaluation or by manually transcribing the results of the automatic generation into the relevant rules. Note that doing so makes rule development and evaluation more expensive and checking for unambiguity and completeness infeasible.

Automated generation of a complex ruleset for control that is complete, unambiguous, and facilitates checking for correctness while still allowing it to evolve efficiently is disclosed.

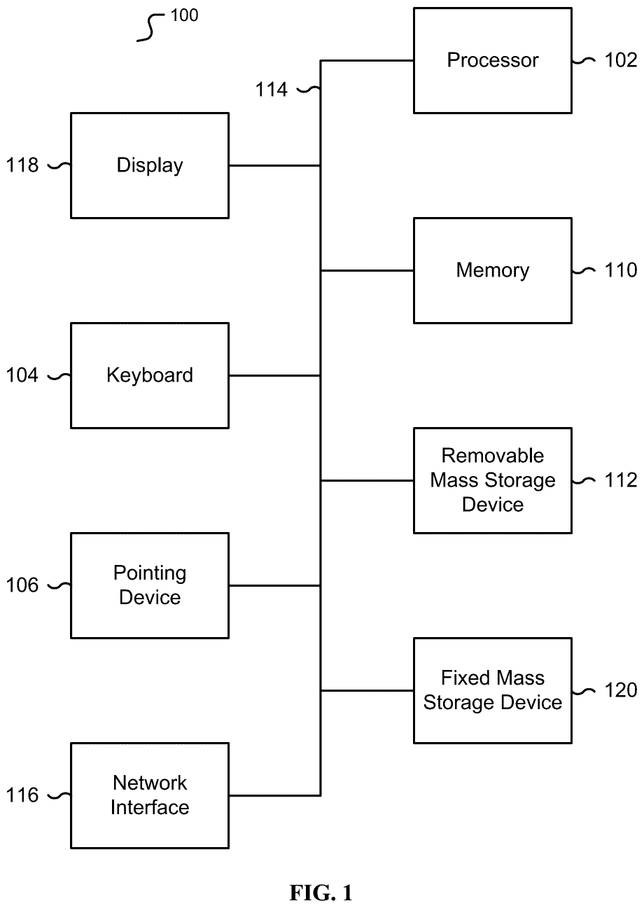

FIG. 1 is a functional diagram illustrating a programmed computer/server system for automated generation of rules and control in accordance with some embodiments. As shown, FIG. 1 provides a functional diagram of a general-purpose computer system programmed to provide automated generation of rules and control in accordance with some embodiments. As will be apparent, other computer system architectures and configurations can be used for automated generation of rules and control.

Computer system 100, which includes various subsystems as described below, includes at least one microprocessor subsystem, also referred to as a processor or a central processing unit (“CPU”) 102. For example, processor 102 can be implemented by a single-chip processor or by multiple cores and/or processors. In some embodiments, processor 102 is a general purpose digital processor that controls the operation of the computer system 100. Using instructions retrieved from memory 110, the processor 102 controls the reception and manipulation of input data, and the output and display of data on output devices, for example display and graphics processing unit (GPU) 118.

Processor 102 is coupled bi-directionally with memory 110, which can include a first primary storage, typically a random-access memory (“RAM”), and a second primary storage area, typically a read-only memory (“ROM”). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as well known in the art, primary storage typically includes basic operating instructions, program code, data, and objects used by the processor 102 to perform its functions, for example, programmed instructions. For example, primary storage devices 110 can include any suitable computer-readable storage media, described below, depending on whether, for example, data access needs to be bi-directional or uni-directional. For example, processor 102 can also directly and very rapidly retrieve and store frequently needed data in a cache memory, not shown. The processor 102 may also include a coprocessor (not shown) as a supplemental processing component to aid the processor and/or memory 110.

A removable mass storage device 112 provides additional data storage capacity for the computer system 100, and is coupled either bi-directionally (read/write) or uni-directionally (read-only) to processor 102. For example, storage 112 can also include computer-readable media such as flash memory, portable mass storage devices, holographic storage devices, magnetic devices, magneto-optical devices, optical devices, and other storage devices. A fixed mass storage 120 can also, for example, provide additional data storage capacity. One example of mass storage 120 is an eMMC or microSD device. In one embodiment, mass storage 120 is a solid-state drive connected by a bus 114. Mass storages 112, 120 generally store additional programming instructions, data, and the like that typically are not in active use by the processor 102. It will be appreciated that the information retained within mass storages 112, 120 can be incorporated, if needed, in standard fashion as part of primary storage 110, for example RAM, as virtual memory.

In addition to providing processor 102 access to storage subsystems, bus 114 can be used to provide access to other subsystems and devices as well. As shown, these can include a display monitor 118, a communication interface 116, a touch (or physical) keyboard 104, and one or more auxiliary input/output devices 106 including an audio interface, a sound card, microphone, audio port, audio input device, audio card, speakers, a touch (or pointing) device, and/or other subsystems as needed. Besides a touch screen, the auxiliary device 106 can be a mouse, stylus, track ball, or tablet, and is useful for interacting with a graphical user interface.

The communication interface 116 allows processor 102 to be coupled to another computer, computer network, or telecommunications network using a network connection as shown. For example, through the communication interface 116, the processor 102 can receive information, for example data objects or program instructions, from another network, or output information to another network in the course of performing method/process steps. Information, often represented as a sequence of instructions to be executed on a processor, can be received from and outputted to another network. An interface card or similar device and appropriate software implemented by, for example executed/performed on, processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Throughout this specification, “network” refers to any interconnection between computer components including the Internet, Bluetooth, WiFi, 3G, 4G, 4GLTE, GSM, Ethernet, intranet, local-area network (“LAN”), home-area network (“HAN”), serial connection, parallel connection, wide-area network (“WAN”), Fibre Channel, PCI/PCI-X, AGP, VLbus, PCI Express, Expresscard, Infiniband, ACCESS.bus, Wireless LAN, HomePNA, Optical Fibre, G.hn, infrared network, satellite network, microwave network, cellular network, virtual private network (“VPN”), Universal Serial Bus (“USB”), FireWire, Serial ATA, 1-Wire, UNI/O, or any form of connecting homogenous and/or heterogeneous systems and/or groups of systems together. Additional mass storage devices, not shown, can also be connected to processor 102 through communication interface 116.

An auxiliary I/O device interface, not shown, can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: flash media such as NAND flash, eMMC, SD, compact flash; magnetic media such as hard disks, floppy disks, and magnetic tape; optical media such as CD-ROM disks; magneto-optical media such as optical disks; and specially configured hardware devices such as application-specific integrated circuits (“ASIC”s), programmable logic devices (“PLD”s), and ROM and RAM devices. Examples of program code include both machine code, as produced, for example, by a compiler, or files containing higher level code, for example a script, that can be executed using an interpreter.

The computer/server system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

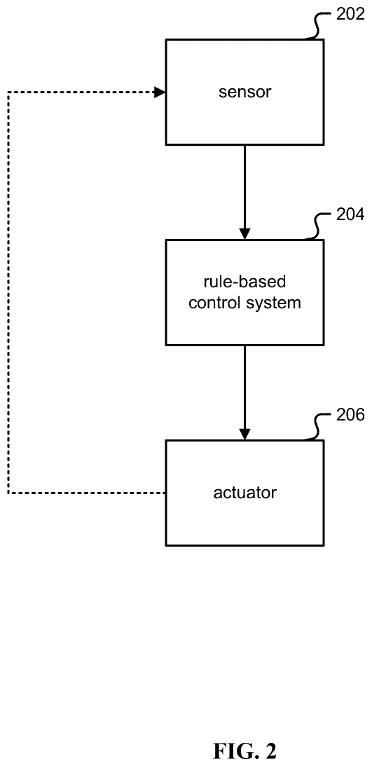

FIG. 2 is a block diagram illustrating an embodiment of a rule-based control system. As shown in FIG. 2, a control loop is formed by a physical sensor (202), a rule-based control system (204), and a physical actuator (206). As the system and/or environment may adjust from output from the actuator (206), a dotted line is shown in FIG. 2 leading to an updated input to the sensor (202) from the system/environment response.

A sensor as referred to herein is anything that detects, measures, and/or responds to a physical property and/or physical record. Examples of a sensor (202) include without limitation: a camera, a pressure sensor, a speed sensor, a fluid level sensor, a load sensor, a position sensor, a torque sensor, a center of gravity sensor, a feedback sensor, an airspeed sensor, a vertical speed sensor, an altimeter, a cabin pressure sensor, a temperature sensor, variable transformer sensors, a force sensor, a vibration sensor, a magnetometer, a gyroscope, a data monitoring sensor, a telemetry sensor, an ultrasonic sensor, an infrared sensor, a speedometer, a tachometer, a tension sensor, a microphone, a mechanical sensor, an electromagnetic sensor, an electronic sensor, a solid state sensor, an optical sensor, a company stock exchange (including a sensor to sense a stock price value), and/or a doctor's senses such as their eyes/nose/hands. In one embodiment, a rule may relate the input from the sensor (202) to a sensor data interpretation.

The rule-based control system as referred to herein is any control system with a specified ruleset that takes input from one or more sensors (202), determines rule conditions that currently hold from the rules in the specified ruleset, and executes the associated rule triggered actions in the specified ruleset using one or more actuators (206).

A physical actuator as referred to herein is anything that causes a physical device to (further) act, display, and/or operate. Examples of an actuator (206) include without limitation: machine controls, aileron control, elevator control, stabilator control, rudder control, wing flaps control, leading edge devices, spoiler control, trim systems, autopilot toggle, ejection seat activator, accelerator, brake control, steering control, parking brake control, lights toggle, communications control, robot arms, LED display, database store, magnetic/optical storage, electromagnetic wave, stock purchase order, and/or a medical diagnosis record.

One example of a rule-based control system (204) is a classification system. For example, the presence of a tiger causes a set of visual effects, including:
a large animal being present;
an animal that has orange fur and black stripes; and
an animal with sharp teeth and claws.

Other animals may cause a different set of visual effects. However, in an application that classifies animals based on appearance, a ruleset may map from visual effects from, for example, a visual sensor (202) to specific animal species or categories that cause those characteristics. That is, a ruleset may map from observing orange fur and black stripes amongst other visual effects and determines a specific animal species/category. The actuator (206) may, for example, thus be a LED display indicating “tiger” or a database store of location/time-stamped records of tigers. This mapping is effectively the classification problem as referred to herein.

Ruleset Operator. An application ruleset automatically computed from a plurality of partial rule sets and a ruleset expression is disclosed. In one embodiment, the ruleset expression is structured as ruleset operations with operands that are either the partial rule sets or the result of other ruleset operators.

In one embodiment, the ruleset operation is implemented in a ruleset compiler as one of the ruleset operators that may be applied to “partial” rulesets. As referred to herein, partial means that the rule in such a set is not necessarily fully specified as required by the application, for example, for an autonomous aircraft, a partial rule may be:
if climbing then raise the elevators.
   There are different degrees of raising the elevators and different categories of climb, from gradual to rapid. Therefore, this rule is partial in the sense of not being specific enough in rule condition or rule action. It is also partial in that it is missing necessary aspects in its condition, such as the current vertical speed and current altitude.

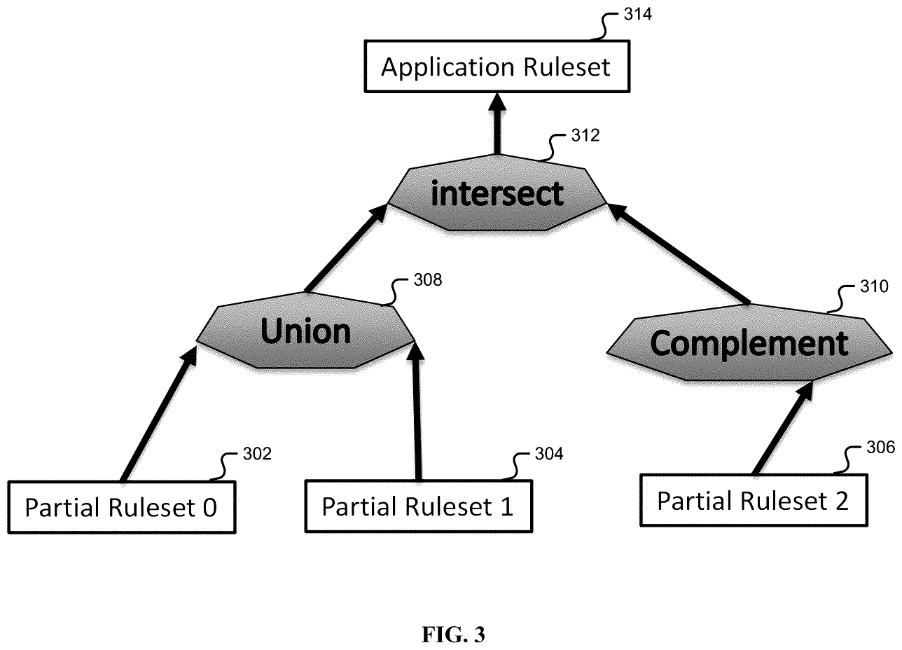

FIG. 3 is an illustration of an application ruleset being computed as an expression in terms of ruleset operations and partial rulesets as operands. In the example shown in FIG. 3, the expression is in the form of a tree. There are three partial rulesets shown, partial ruleset 0 (302), partial ruleset 1 (304), and partial ruleset 2 (306). One ruleset operation, a union (308), represents a union of partial ruleset 0 (302) and partial ruleset 1 (304). Another ruleset operation is a complement (310) of partial ruleset 2 (306). Another ruleset operation is an intersection (312) of the union (308) and the complement (310).

The application ruleset (314) is thus automatically generated from a ruleset expression, wherein the ruleset expression may be expressed as:
Intersect(Union(Partial0,Partial1), Complement(Partial2))

Automatically computed as referred to herein means having a ruleset compiler that generates a ruleset from a specified ruleset expression, an example of which is given in FIG. 3. That is, the evaluation of this expression to produce the application ruleset is automatically performed by a compiler.

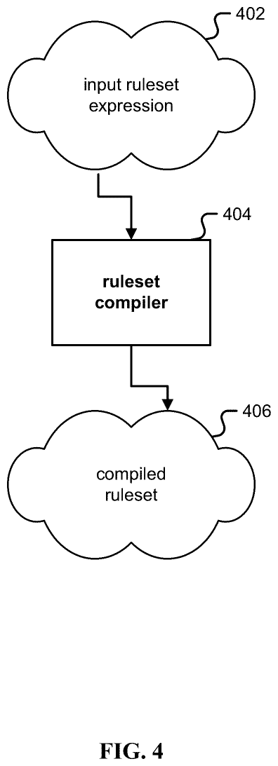

FIG. 4 is an illustration of an embodiment of processing of a ruleset compiler. One or more input ruleset expressions (402), for example, the one shown in FIG. 3, is input to a ruleset compiler (404). In one embodiment, the ruleset compiler (404) is a software package on a computer such as that shown in FIG. 1. In one embodiment, the ruleset compiler (404) comprises dedicated special hardware designed for efficient compilation. The output of the ruleset compiler (404) is a compiled ruleset (406). This automatically computed compiled ruleset is efficient for practical application, for example, a reduced latency autonomous vehicle application such that the compiled ruleset (406) is executed every 50 ms or less. In one embodiment, the compiled ruleset (406) is carried out by the system of FIG. 1.

An observation made herein is that a rule may be viewed from a set perspective. In particular, a rule condition may effectively define a set of scenarios, namely those in which the rule condition is true. That is, a rule condition may be interpreted as designating set membership, namely for a given rule R, the set of all input scenarios for which the rule condition for R evaluates to true. Thus, it may be considered a set membership predicate.

Similarly, an action normally designates a set of specific actions because, for instance, there are parameters to the action. For example, in autonomous aircraft, an action may be to increase airspeed by 30 percent. Thus, the actual action on the throttle may depend on various factors including the airspeed, current pitch, altitude, and other factors. Therefore, a rule may be viewed as a membership implication between one set, the rule condition set, such as a set of input scenarios matching a rule condition, and a second set, the action set, such as a set of actions.

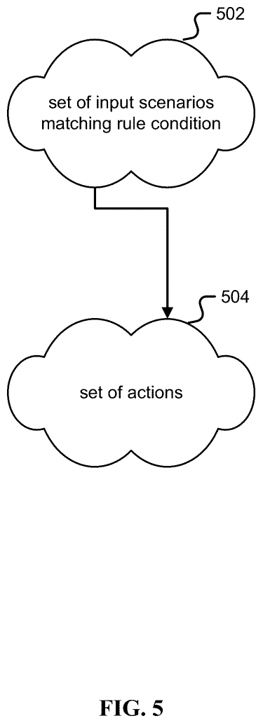

FIG. 5 is an illustration of a rule as a mapping from the rule condition set to the rule action set. As shown in FIG. 5, if the current inputs are matching the rule condition set of this rule (502), the action carried out is in the action set of the rule (504). Therefore, rules may be automatically computed at least in part by set operations on these two sets. In one embodiment, the rule condition computation is based on set operations. However, set operations on rules may require rule-specific considerations in order to preserve the rule semantics and be practical.

Also, in practice, a ruleset may be developed as a set. It may not be feasible to deal with individual rules, one at a time, to provide an adequate solution, as a system may require a set of rules that are complete, consistent, and unambiguous. These are properties of the ruleset as a whole and may not be determined by examining individual rules independently. Set operations are thus applied to a set of rules but also with rule-specific aspects to the set operations in order to preserve rule semantics. Practically, these ruleset operations may be operations on sets of sets. These operations may therefore be qualified as “ruleset intersection,” “ruleset union,” and so on.

Rulesets may be regarded as “partial” in the sense that there are additional aspects that may be added to rule conditions and actions to make the ruleset more specific or more complete. For example, an autonomous aircraft control rule set may consider flight operations as well as traffic in the area. However, the ruleset may be missing inputs on other factors that may influence the flying, such as the fault status of the aircraft and rules that determine whether it is safe to take-off or if in flight, whether to continue, for specific faults. This view is consistent with set theory where any set may be regarded as a subset. However, herein, the term subset is deprecated as it may not recognize the rule structure to sets of interest. It may poorly suggest that a ruleset is missing rules wherein more commonly, a partial rule set is missing subconditions.

A ruleset automatically compiled from applicable partial rules in partial rule sets that are inputs (that is operands) to a ruleset operation is disclosed. These operations include ruleset intersection, union, difference, complement, and cross-product and in various combinations of those, as described below.

Ruleset Intersection. A ruleset intersection may be an operation or operator taking two or more partial rule sets as operands and compiled by forming a rule for each combination of partial rules, one from each of the intersecting partial rule sets. As referred to herein, two rules intersect if their action sets intersect and their rule condition sets intersect. Thus, ruleset intersection is the pair-wise intersection of rules in the constituent partial rule sets of the intersection. When the rule action of one partial rule PRi intersects with the rule action PRj, the conjunctive condition applies to the intersection of action sets.

For example, if a partial rule from one set applies to flying, and a partial from another set applies to high flying, the conjunctive rule condition applies to just high-flying. However, if there is also a rule in one of the operand rulesets that applies when flying but not flying high, intersection also includes the modified version of this rule, modified to indicate “not flying high.”

As an illustration, in the single case of specific rule actions, in generating a rule for intersection for action AA from two partial rule tables PRT0 and PRT1, if partial rule PRi has action AA and has a condition PRiC that is true for the set of scenarios in set A and partial rule PRj has the same action AA and has a condition PRj c that is true for the set of scenarios in set B, then the rule for the intersection has a rule condition that corresponds to the intersection of sets A and B, that is PRiC AND PRjC.

In one embodiment, partial rule sets are not ambiguous and the ruleset intersection is compiled between partial rules with intersecting action sets. This is more efficient than considering intersections between all combinations of partial rules. It is sufficient with partial rule sets that are not ambiguous. This is because rule conditions do not intersect unless action sets intersect. This can be shown because if PRi and PRj are on different actions, the conjunction of these rule conditions would be unsatisfiable and/or non-intersecting, or else there would be an input scenario for PRi that matches the rule condition PRj, or vice versa. Otherwise, there would be no input scenario in the conjunction. If that is the case, then the partial rule set PRT0 containing PRTi is ambiguous. That is, an input scenario would match two different actions. As an improvement, considering partial rules with intersecting action sets is more efficient and results in fewer rules that are not satisfiable; that is, the rule condition may not be true.

In one embodiment, at each decision point at run-time, that is rule evaluation stage, each rule produced by ruleset intersection may be evaluated by separately evaluating the rule condition of each partial rule set that is an operand to the intersection and then treating the rule as matched if every one of these operand evaluation results are true. Using the example above to illustrate, the evaluation would evaluate PRiC and PRj c and treat the actual rule condition as true only if both evaluate to true.

In one embodiment, a ruleset is compiled into a more efficient form by combining and simplifying the rule condition that results from ruleset operations. For example, if PRiC and PRjC contain a common subexpression C0, the intersection rule condition can be simplified by identifying this common expression C0 and evaluating it once, rather than twice, i.e. once in the context of PRiC and then again in the context of PRjC.

Performing set operations on arbitrary rule condition expressions may lead to expensive rule condition evaluation without the combining and simplifying taught above yet it may not be necessarily possible/understandable in the general case how to simplify the compiled rule condition other than combining them with logical operations. For example, if RC0 and RC1 are two arbitrary rule conditions, and RC0 contains a condition (f(x)<y), it is not generally feasible to simplify the rule condition for the intersection of these two rule conditions. Therefore, the run-time rule evaluation can evaluate the rule condition as RC0 && RC1. Moreover, it may not even be feasible to determine if this expression is satisfiable so it may be fully evaluated at each rule evaluation time even though it may not evaluate to true.

Identified Subconditions. Use of identified subconditions may aid with this issue. In one embodiment, a rule condition is composed of a plurality of identified subconditions with this identification being specified across these partial rule sets. For example, currentAirspeedModerate may be the name of an identified subcondition. This identification has the same meaning in each of the partial rules in the collection of partial rule sets. In particular, if currentAirspeedModerate is an identified subcondition in two partial rulesets in an expression, this subcondition has the same meaning in both.

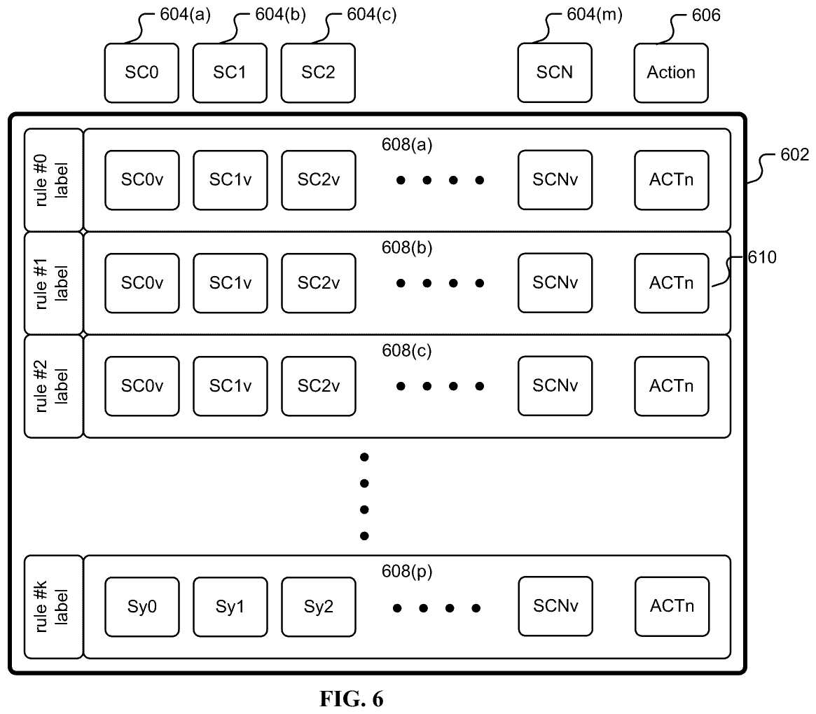

FIG. 6 is an illustration of a representation of rules in a table using identified subconditions that, as a conjunction, represent the rule condition. In one embodiment, a representation of partial rules is as a table (602) with a labelled column per identified subcondition (604(a) through 604(m)) as well as a column (606) labelled action or decision.

A rule is represented by a row (608(a) through 608(p)) in this table. In a given row, for example row (608(b)), the rule condition is realized as the conjunction of the subcondition columns (604(a) through 604(m)) and the rule action is designated by the row entry in the decision/action column(s), for example (610). A column may be designated as storing an arbitrary rule condition expression.

A disjunction in a rule condition may be handled in this table format by multiple rows, one for each subexpression of the disjunction. Therefore, all rule conditions may be represented in this table format. Equivalent to this row-based representation of rules, the table representation may be pivoted so that each column corresponds to a rule and each row corresponds to a subcondition or action.

In one embodiment, a rule generated by intersection has a rule condition that contains the intersection of the identified subconditions of each of the partial rules that are operands to this intersection. Therefore, each identified subcondition is evaluated once even though it occurs in each of these partial rules. For instance, if there are partial rule tables PRT0, PRT1 and PRT2, the rule condition for an application rule may be generated for rule action RA to include a subcondition identified by SCi based, at least in part, on the subcondition SCi in the selected partial rules in each of PRT0, PRT1 and PRT2. For example, if SCi is currentAirspeedModerate, meaning this is required to be true, in each of the partial rules, then the rule condition of the generated rule includes currentAirspeedModerate. That is, the row corresponding to this intersection may have the value true in the table entry corresponding to its row and the column labelled currentAirspeedModerate.

In one embodiment, an identified subcondition can be qualified, for example, currentAirspeed:moderate or currentAirspeed greater than X. In general, a qualifier is defined herein as an expression that can be evaluated during rule evaluation.

In one embodiment, a qualified identified subcondition for a compiled rule is determined by selecting the identified subcondition qualifier that is the intersection of the same identified subcondition in each of the applicable partial rules. Here, subcondition qualifier intersection as referred to herein means a qualifier that is true if and only if true for each of the same-identified subconditions in the applicable partial rules. This intersection may be determined by the conjunction of these same-identified subconditions and creating a qualifier for this conjunction. In one embodiment, the conjunction can be used directly. However, in some cases, there is a qualifier that is known to correspond to the intersection. For example, if one partial rule has the current airspeed subcondition qualified as lowToMedium and another is qualified as mediumToHigh, the generated rule has the current airspeed subcondition qualifier identified as medium, because that is common to both of the partial rules. In the case that a partial rule specifies “don't care” for a particular identified subcondition, this partial rule has no effect on the intersection because any result for this subcondition is effectively true for it.

In one embodiment, the ruleset intersection is compiled as the intersection of rules in the constituent partial rule sets where the intersection of individual rules is computed as the intersection of the identified subconditions in the rule conditions which is computed as the intersection of the qualifiers on these identified subconditions.

In one embodiment, one or more qualifiers for an identified subcondition are defined as a range of values for a particular value. For example, the medium qualifier used earlier may correspond to an airspeed between 200 mph and 300 mph. For these subconditions, the intersection of two subconditions may be computed efficiently as the range corresponding to the overlap between these two ranges. Moreover, it may be efficient to determine if the intersection is not satisfiable; that is indicated by the range being empty. For instance, if one partial rule in the intersection specifies airspeed less than 100, and another specifies airspeed greater than 100, the intersection is simply null or empty.

In one embodiment with identified subconditions where the qualifiers refer to ranges, an application rule set with N identified subconditions can be regarded as classifying regions of an N-dimensional space, where each dimension corresponds to a subcondition and each qualifier associated with this subcondition refers to a range in that dimension. A rule condition effectively defines an N-dimensional hyper-rectangle by the conjunction of its subcondition qualifiers. The application rule condition may be viewed as being generated by geometric operations on the regions defined by the applicable partial rule conditions. In particular, the generated rule for intersection has a condition that corresponds to the geometric intersection of the regions defined by the rule condition of each of the applicable partial rules.

In one embodiment, the conjunctive inclusion of a partial rule set may designate the complement of the rule conditions in a given partial rule set. Here, the applicable rules are recognized as those specifying the complement of the rule action of the rule being compiled. Then, a condition from a partial rule is incorporated in the generated rule as the complement of its condition. This complement mechanism allows a “prohibitive” ruleset to be used in determining a constructive application rule set. That is, as referred to herein, the generated rule has a rule condition that indicates when a given action can be performed as well as when it is allowed to be performed, the latter based on it not being prohibited. Note that the conversion from prohibited to its complement may produce multiple ranges for a given subcondition, thereby requiring multiple generated rules. For example, if some action is prohibited between 1000 and 2000 feet of altitude, there is a rule generated for the altitude being below 1000 feet and one generated for the altitude being above 2000 feet.

In one embodiment, a partial rule in a partial rule set can specify as its rule action a range or plurality of actions. One form is the negation of an action, which is interpreted as the complement of this action in the set of actions.

Applicable Partial Rules. In one embodiment, a partial rule for a given application rule being generated is identified as applicable by having an action that is relevant to the action of application rule. In the simple case, the action of the partial rule matches that action for the application rule being generated. In a more sophisticated case, a partial rule is applicable if its action is a category of actions that includes the action for the application rule being generated. One case of “same category” is the application action being derived from the action in the partial rule. In another case, a partial rule is applicable if its action is a subaction of the action for the application rule being generated. A subaction as referred to herein is normally one of the steps required to perform this top-level action.

In one embodiment, a partial rule may specify a condition that is a sequence of subconditions that correspond to subactions. For an example, in autonomous aircraft, a rule may say that turning left is comprised of the subactions of banking to the left by angling the ailerons, arising the elevators slightly, increasing the throttle, and then reducing the banking back to level. That is, a rule that satisfies these subaction subconditions implies it is performing the associated action, and rather than indicating an action in the future, it indicates that the action has been completed if the rule condition holds. This form of partial rule allows the compiler to recognize that a partial rule that is associated with a subaction is applicable to the application rule being generated.

In one embodiment, a given application action is a restricted case of another action, possibly by a partial rule. That is, from an object-oriented programming standpoint, the restricted action is derived from the base action. For example, a partial rule may apply to the climb action which may have specific application actions of Slow climb, moderate climb, and rapid climb. The Slow climb, moderate climb, and rapid climb are regarded as derived from the base climb action. The rule compilation then treats the base rule as applicable when generating rules for one of the derived actions, that is, the base rule action set includes as subsets the derived action sets. As referred to herein, the rules for derived actions inherit the conditions associated with their base rules. If a partial rule set includes a partial rule for a base action as well as a derived action, the rule compilation uses the rules with the most derived action that is equal to or a base for the current application action being considered.

In one embodiment, actions are categorically identified, similar to identified rule subconditions. For example, an action may be elevator: neutral designating that the aircraft elevators may be positioned in the neutral position.

In one embodiment, the rule action may be specified as a plurality of identified actions, that is a vector of identified actions. For example, a decision may be a vector such as [elevator:neutral, throttle: 80percent, ailerons:neutral].

Note that segmenting partial rule sets by actions or categories of actions is feasible but is primarily an optimization to reduce the size of a partial rule set. For example, rather than having a partial rule set that contains all the partial rules for the dynamics of flying, this partial rule set may be partitioned into partial rule subsets for each different action, such as climbing, ascending, cruising, and so forth.

Union. A ruleset may be specified as the union of two or more partial rule sets. In particular, the union rule set of partial rule sets A, B, and c is one as referred to herein which contains rule Rif it occurs in at least one of A, B, and c, for each such rule R. The set of identified subconditions is also the union of those in the constituent partial rule sets. The action vectors of each of these partial rule sets are assumed to have identified actions, with a common meaning to an action identification across the partial rule sets, similar to identified subconditions.

The result for a union is a vector of results from each of the constituent partial rule sets. Thus, a union of A, B, and c as above produces a result vector [a, b, c] capturing one result from each of its constituents. That is, the union set has a union action vector. Rules from different operand rulesets may specify the same action. In this case, a union may provide additional rule conditions for the same resulting action. For example, if one partial rule set PR0 has the rule RC1→A0 and another partial rule set PR1 has the rule RC2→A0, then the union of these two rule sets includes both these rules. If the two rules have the same rule condition, they can be merged into a single rule in the union that specifies this common rule condition and both of the associate actions. Other optimizations to merge rules are possible. Note that the union may produce a rule set that is ambiguous, that is, produces different decision results on the same input scenario even if the operand rulesets are not ambiguous.

In one embodiment, a prohibitive ruleset may be generated as the union of multiple prohibitive partial rule sets.

The union operation allows the development of partial rule sets for separate phases of a controlled systems operation. As an example, there may be a partial rule set for taxiing an autonomous aircraft as well as one for flying and one for landing. In this example, there may be no overlaps in rules because the taxiing ruleset applies when altitude is essentially zero and the airspeed low, the flying one applies for proper airspeed and the landing gear up, and the landing ruleset applies when the landing gear is down. It also allows for the separate development of rules for the control of separate subsystems, one partial rule set for each. A ruleset union operation may automatically combine these component partial rule sets into an application rule set that handles all of the systems. As an example in autonomous aircraft, there may be separate partial rule sets for each of elevator, throttle and ailerons. A ruleset union operation automatically combines these component partial rule sets into an application rule set that handles all three of these subsystems. In each of these cases, developing the partial rule set for each phase or subsystem separately is simpler than directly developing the combined rule set directly. As an improvement, performing rule evaluation on the combined rule set is more efficient in space and processing than performing separate rule evaluations on each of the partial rule sets, especially with rule merger optimizations, as mentioned above. Therefore, development efficiency does not compromise deployment/production efficiency or vice versa.

Ruleset Cartesian Product. A ruleset Cartesian product as referred to herein is produced logically by producing a rule for each combination of elements selected from each of the operand rulesets. For example, if RC0→RA0 is a rule in operand set X and RC1→RA1 is a rule in operand set Y to the Cartesian product operator, the resulting ruleset contains the rule

RC0→RA0,RC1→RA1

meaning that if RC0 is true, then RA0 is taken, and if RC1 is true then RA1 is taken, and both actions are taken if both conditions are true. With identified actions, if two such rules refer to the same action, this same action is taken if either or both of the associated conditions are true.

One use of the ruleset Cartesian product is having a partial rule set for each identified, qualified subcondition of interest, with each such ruleset containing a rule with a rule condition comprising the single subcondition for each qualifier of that subcondition. For example, if one of the identified subconditions is temperature and it has the qualifiers cold, warm and hot, there is a rule with rule condition temperature::cold, one with rule condition temperature::warm and one with rule condition temperature::hot. Then, if each of these rules has the same action, such as unknown, the Cartesian product is a ruleset that completely covers all possible input conditions for a ruleset that uses these subconditions of interest.

Ruleset Complement. A complement of a ruleset ARS is a unary ruleset operation referred to herein as producing the ruleset that contains, for each rule R in ARS, a resulting rule that has as a rule condition that is the negation of that of R and a rule action that is the complement of the rule action of R. The complement of a rule action RA comprises all the potential actions that are not RA, or not in RA if RA is a set of actions. If the rule action is a vector of identified actions, the complement rule action is the complement for each identified action.

In one embodiment, a ruleset is automatically simplified in some cases when there are multiple rules with the same rule condition that correspond to most of the possible actions in the range of potential actions. For example, if the possible actions are RA0, RA1 and RA2 and there are rules:

RC0→!RA0

RC0→!RA1

where the ! symbol denotes negation or complement, then the ruleset can be simplified by replacing these two rules with the single rule

!RC0→RA2

In one embodiment, the ruleset complement provides multiple rules for a given rule R in the operand ruleset to represent the complement of the rule action in R. Building on the previous example, if the operand ruleset contains:

!RC0→RA2

then the complement is represented as:

RC0→!RA0

RC0→!RA1

that is a plurality of rules whose actions together constitute the complement of RA2. In this case, the ruleset complement of the complement produces the original ruleset as expected.

There is also a ruleset relative complement that produces a ruleset that contains all the rules in a first ruleset that are not in the second ruleset operand. One use of this ruleset relative complement is to have the first set be a cross-product ruleset that covers the entire possible input domain. Then, the ruleset relative complement of some ruleset RS is non-empty if RS is not complete for the domain.

In one embodiment with identified, qualified subconditions, the cross-product or ruleset Cartesian product ruleset may contain a rule with a rule condition for every possible combination of qualifiers for the identified subconditions, as described above.

As a simple example, if there is an airspeed identified subcondition with qualifiers: fast, moderate, and slow, and an altitude identified subcondition with qualifiers: low, medium, and high, the cross-product on these qualifiers produces a rule with a rule condition for each of:
fast-low, fast-medium, fast-high
moderate-low, moderate-medium, moderate-high
slow-low, slow-medium, slow-high
   (i.e. 9 different rules) with the rule action for each being a fixed unknown indication. For example, using the earlier example, if ARS did not contain rules with rule condition for fast-high and slow-low, the resulting partial ruleset of the relative complement of the Cartesian product ruleset would contain two rules, namely:

unknown←fast and high

unknown←slow and low

The resulting partial rule set contains rules that match scenarios that are not matched by any of the rules in ARS.

Ruleset Difference. The ruleset difference is referred to herein as the same as set-theoretic difference, namely as the ruleset complement of the ruleset intersection of the operands. Therefore, it may be compiled as compiling this intersection and then producing the complement as described earlier.

Ruleset Mirroring. In some systems, there is a symmetry between conditions and rules. For example, in controlling an aircraft, banking left and banking right are mirror operations. Also, the subcondition of traffic to the left is the mirror of traffic to the right.

In one embodiment, a partial rule set may define, as referred to herein, a subcondition to be mirror of another subcondition, a mirror subcondition, and an action as the mirror of an existing action, referred to herein as a mirror action. Then, a partial ruleset can be mirrored by this mirror to produce a mirror ruleset of the first operand ruleset. For an example in autonomous aircraft, suppose that rightClearTraffic is the mirror subcondition of leftClearTraffic, and rightBankIntent is the mirror subcondition of leftBankIntent, and bankRight action is the mirror action to a bankLeft action. Then, if the first operand ruleset contains the rule:

bankLeft←airspeedAdequate AND leftClearTraffic

then the mirror ruleset may contain the rule:

bankRight←airspeedAdequate AND rightClearTraffic

That is, a rule is produced automatically by the compiler where the action is the mirror action of the original rule and the rule condition is produced by substituting a mirror subcondition for each subcondition with a mirror in the original rule condition, and just using the original subcondition for subcondition SC if there is no mirror subcondition for SC. The application ruleset may be produced by taking the union of the first operand ruleset and its mirror. Thus, in this example, the first operand ruleset deals with actions to the left and straight ahead. The mirror operation adds in the rules for going to the right. As with the other ruleset operations, a rule produced by mirroring may be overridden by directly specified rules in the top-level ruleset or another operand ruleset. Thus, mirroring does not have to result in an exact mirror set of rules.

Using this mechanism, the developer of a system that has this symmetry may specify or generate a much smaller partial ruleset for one side as an improvement in design time, run time, and computing resource efficiency, and then use the mirroring to complete the ruleset automatically.

In one embodiment, a mirrored rule is produced for any rule in the first operand set that has a mirrored subcondition with the action designated as the original action plus a mirror prefix or suffix. For example, the above example would produce the rule

bankLeft-mirror←airspeedAdequate AND rightClearTraffic

rather than designating the action as bankRight. Thus, there is no need to specify the mirror action designation, which is an improvement in design time efficiency.

In one embodiment, the mirroring is specified in a ruleset that indicates/makes the mirroring conditional on other subconditions. For example with an aircraft, there is some symmetry to climbing and descending, but primarily in the case airspeed is above some threshold. By adding the airspeed subcondition, the mirroring is applied within this threshold. With the provision of extra subconditions for mirroring to match and the overriding mechanism, ruleset mirroring requires an actual compiler mechanism that incorporates knowledge of the rule structure. It may not be implemented directly by a simple textual substitution.

In one embodiment, the mirroring mechanism can be used to produce an inverted ruleset. For example, if an autonomous aircraft requires the ability to fly upside down as well as right side up, there may be a need for an inverted ruleset. In particular, in the inverted position, banking left requires the opposite actions to the normal upright position. That is the ailerons are positioned in the opposite way as are the elevator and rudder. In this case, the mirroring rules can specify both a mirror and inversion mapping. For example, a bankRight normally requires lowering the left aileron and raising the right aileron, whereas the inverted rule requires raising the left aileron and lowering the right aileron. Using the mirroring mechanism in the case of inverted flight, the rules for inverted flight may be produced automatically from the ruleset for upright flight with the inverted rules possibly labelled as inverted-bankRight, and so on, thereby allowing the union of the upright and inverted rulesets to produce a single application ruleset automatically from one that deals with maneuvers to the left during upright flight. This is an improvement because it requires less design time, run time, and computing resources.

In general, the mirroring mechanism provides a conditional remapping of rule subconditions to produce a revised ruleset that may then be either used separately by the application or combined into another ruleset using it as an operand to the other ruleset operations. The mirroring and inverse examples illustrate merely two uses of this conditional remapping mechanism.

Techniques for Ruleset Operations. In one embodiment, a technique for performing ruleset intersection is implemented as a recursive method that takes as input a current working rule (CWR) and a next one of the operand rulesets and includes the steps:
1. On initial invocation, use the first operand ruleset and a default rule for CWR, otherwise:
   2. if there is not a next operand ruleset, then output the CWR as a rule in the output ruleset and return;
   3. else for each rule R in this next operand ruleset:
      a. intersect R with CWR to produce a new rule NR;
      b. if NR has a satisfiable rule condition and a non-null rule action then recursively invoke this method with NR as the new CWR and the next operand ruleset;

A rule condition is “satisfiable” as referred to herein if there is at least one input value combination that causes it to be true. A rule action is non-null if there is at least one action in common between the CWR and selected rule R. The default rule specifies a rule condition that matches on the entire input space and any rule action, so the default rule intersection with any rule R is the rule R itself.

In one embodiment with identified subconditions, the intersection of a rule condition is computed as the conjunction of each pair of identically identified subconditions between CWR and R. If an identified subcondition is missing from one of these rules, it is treated as “don't care” so the intersection is the clause, value or range of the identically identified subcondition in the other rule.

In one embodiment, a technique for performing ruleset union is implemented similarly as described above for a ruleset intersection except that in step 3(a), R is unioned with CWR rather than intersected. Here, a union of R and CWR produces a rule that has both actions of these two rules to be invoked when both of their respective rule conditions evaluate to true as well as a rule for the R action when only the rule condition for R is true and not the rule condition for CWR. And a rule for the opposite case of CWR firing but not R. It is an error if the two rule actions are contradictory and the respective rule conditions are overlapping in the sets of input value combinations for which they are true.

In one embodiment, a technique for cross-product or Cartesian product is implemented similarly as described above for a ruleset union. It is primarily used instead of union to skip checking the overlaps in conditions or conflict checks, such as when the rule conditions or actions are all the same, so there are no conflicts. In one embodiment with rule conditions as a conjunction of qualified identified subconditions, the cross-product is generated from a list of these subconditions, generating a rule for each combination of qualifiers across all of the listed subconditions.

In one embodiment, a technique for ruleset complement is a simple iteration of the rules in the operand ruleset, creating an output rule for each rule R with a rule condition that is the complement of the rule condition in R and the complement of the rule action for R. In some rule systems, the complement may not be expressed in a single rule so multiple rules are generated for a given rule R.

In one embodiment, a technique for ruleset difference is a combination of intersection and complement, as noted herein. In one embodiment, a technique for mirroring is also a simple transformation per rule in the operand ruleset.

Prioritized Union, Prioritized Rulesets and Inheritance. In one embodiment, a prioritized union ruleset operation as referred to herein produces a prioritized ruleset by assigning a priority to each of the rules in each operand ruleset as part of adding each to the resulting ruleset. If an operand RS0 to a prioritized ruleset union is already a prioritized ruleset, the priority assigned to the rules from RS0 in the result prioritized ruleset is based in part on the priority assigned to RS0 by the prioritized union. For example, a prioritized ruleset that is the result set of a prioritized union of prioritized rulesets RS0 and RS1 is

prioritizedResultSet=RS0 prioritized-union RS1

and has every rule from RS0 assigned a higher priority than any rule from RS1. This is because the priority assigned to a ruleset in this example is implicit in the order of the operands.

A prioritized union may explicitly specify the priority associated with each of its operands, for example

prioritizedResultSet=A(100) prioritized-union B(1000)

Alternatively, the priority may be implicit in the order of operands to the prioritized union as in the earlier example.

In one embodiment, a ruleset RS may be directly specified with a priority for each rule, as provided traditionally in some ordered or prioritized rule systems. This is equivalent to producing the ruleset from a prioritized union of a list of rulesets that contains in total all the rules in RS and in which the prioritized union assigns those same priorities.

Traditionally in a prioritized ruleset, if two or more rules match on a given input, the rules out of that matching set that are activated are chosen based on priority. For example, in a simple case, if rule Ri and Rj both match and Ri is priority 3 and Ri is priority 5, using the traditional computing model of a lower number being a higher priority, Ri is activated and the matching to Rj is ignored. Effectively, Ri overrides rule Rj. The priority of a rule may be explicitly specified in each rule in a ruleset. Alternatively, the priority of a rule is implicit in the order in which the rule occurs in the ruleset. Therefore, the matching is equivalent to the matching in network access control systems and order-based rule conflict resolution in traditional general rule-based systems. This prioritized ruleset is technically a rule list, rather than a set, because it is ordered. In this case, it is common for a rule earlier in the list to be viewed as higher priority than one later in the list.

The prioritized union ruleset operation assigns priority to rules across an entire ruleset in one operation rather than requiring the priority to be set in each individual rule, as in traditional systems. It also allows prioritized rulesets to be combined and have the individual rule priority of each rule in an operand ruleset to be automatically adjusted, that is recomputed, according to the priorities assigned by the prioritized union to each operand ruleset, as each such rule is added to the result ruleset. Finally, it allows for what are otherwise conflicting rulesets to be combined by union relying on priority-based conflict resolution while still optionally indicating conflicts among rules with the same priority.

A prioritized ruleset union may be used to achieve a similar functionality to inheritance with rulesets. Here, the term inheritance as referred to herein is similar to the inheritance mechanism as used in object-oriented programming (OOP). In particular, a derived ruleset as referred to herein is produced as the prioritized union of the base ruleset BRS and one or more higher priority extending rulesets ERSi that specify the derived rules. Thus, any rule ER in an ERSi that matches on some input to the same condition as a rule BR in BRS overrides the action of BR when there is a match of the inputs in this overlap region. Also, any rule in ERS that does not overlap with those in BRS extends BRS with this additional rule, consistent with the behavior of derivation. By structuring the derived rules as more specific than the base rules, following the normal OOP inheritance approach, the priority may be used to achieve the traditional specificity criteria for rule conflict resolution, but with the improvement of better computing time/resource efficiency of comparing priorities. In one embodiment of a deriving prioritized union ruleset operator, a rule whose rule condition overlaps with a base rule condition is automatically assigned a higher priority than the base rule with which it overlaps.

In one embodiment, a ruleset inheritance operation is realized as a prioritized ruleset union in which a derived rule is automatically assigned a higher priority than its base rule. Also, optionally the compiler ensures that the condition of a derived rule matches a subset of the scenarios that the condition of the base rule matches. Note that ruleset inheritance differs in certain aspects from normal object type inheritance. This is because the result set may be produced from multiple extending rulesets, that is, there may be multiple base rulesets in a single inheritance operation. Also, ruleset inheritance may be implemented as per-rule inheritance across all the rules in the operand partial rulesets. Furthermore, ruleset inheritance produces a single result ruleset whereas with traditional OOP inheritance, each derived type is a different type being generated.

In one embodiment, priority is indicated by inheritance. In particular, a derived rule is indicated as having a base rule, which implicitly indicates that the base rule is lower priority. That is, the inheritance between rules is indicated and those indications implicitly indicate their priority. Because a derived rule condition set is strictly a subset of the conditions matched by the base rule, relative priority between inheritance-related rules is all that is needed. That is, a rule may not override a rule unless it is a base rule of R, directly or indirectly.

In one embodiment, other ruleset operations herein are provided that support prioritized rulesets. In particular, ruleset intersection may treat two rules from its operand rulesets as intersecting if the two rules are the same priority. A ruleset complement operation may invert the rules in the operand ruleset separately for each priority as it adds these rules in the result ruleset. The prioritized Cartesian product may adjust the priorities of the rules from the operand rulesets as it generates the individual rule combinations. For example, the priority of all the rules from the first operand ruleset may be adjusted to be higher than those of the second operand ruleset. This adjustment typically matters when there is overlap, that is intersection, between the operand rulesets.

Ruleset Composition and Indirect Reference. In one embodiment, a ruleset composition operator composes a first operand partial ruleset with a second operand that is a set of other partial rulesets to produce a resulting ruleset by treating the action in each rule in the first operand ruleset as identifying a partial ruleset in the second operand set. That is, the action designation in a rule is interpreted as a reference to one of these other partial rulesets. This may be written as:

resultingRuleSet=compose(toplevelRuleSet,setOfPartialRulesets)

In this resulting ruleset, the second operand rulesets may be considered components of the top-level/first operand ruleset. During rule evaluation, if a rule condition of a rule in the top-level partial ruleset evaluates to true, the rule evaluation continues in the partial ruleset that is designated by the action of this top-level rule.

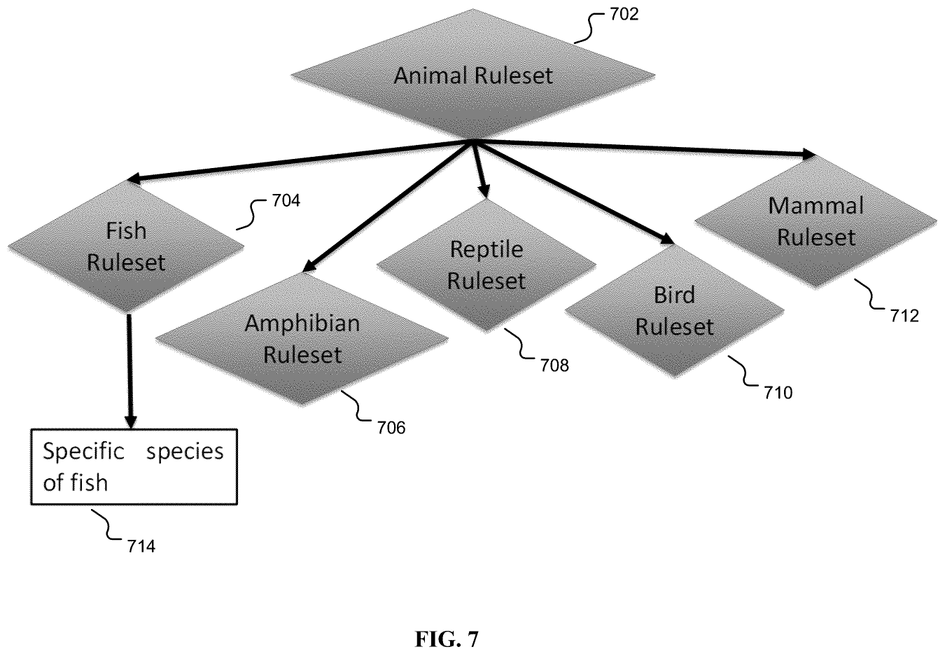

FIG. 7 is an illustration of hierarchical classification using indirect reference to partial rulesets. In the example shown in FIG. 7, with a rule-based classifier of animals, a first-level ruleset (702) may classify based on whether a particular vertebrate animal is fish (704), amphibian (706), reptile (708), bird (710), or mammal (712), and then a second-level of partial rulesets may classify down to a specific species such as a specific species of fish (714). Each rule in this first level partial ruleset has an action that refers to a next level ruleset which further refines the classification. In particular, the rule evaluation continues in the fish partial ruleset (704) if a first-level rule matches whose action or decision rule corresponds to fish. This fish partial ruleset can classify down (714) to a specific species of fish, as shown in FIG. 7.

The operands to the composition operator are partial rulesets or sets of partial rulesets because each of these rulesets may not handle all the decision rules required in the application domain, but a subset of them. For example, in the above, the fish partial ruleset (704) may not classify all other types of animals, such as bird, and so on.

The ruleset composition operator effectively allows a common subset of rules to be factored out and specified in one of the component rulesets. For example, if there are two ways of classifying to fish, rather than duplicating the fish rules for the two cases, the top-level partial ruleset (702) has two leaves that map to the common component fish partial ruleset. It also allows a partial ruleset for more specific cases to be developed separately from other specific cases.

To illustrate with the above example, the partial ruleset for fish may be developed by a fish expert independent of the partial rulesets for other classes of animals. It also means that the separate partial rulesets may be revised independently, possibly even during the application operation. For instance, a correction to fish rules may not require rebuilding other rulesets. Furthermore, this indirection may reduce the cost of ruleset evaluation. This is because the cost of ruleset evaluation is somewhat proportional to the number of rules in the ruleset. In this example, if there are K rules in each of the component partial rulesets and L in the top-level ruleset, the rule evaluation cost is effectively K+L whereas the total rules across all partial rulesets would be a much larger number N.

The ruleset composition operator also may automatically check that every action in the first partial ruleset identifies a partial ruleset in the second operand, and may also indicate if any partial rulesets in the second operand are not referenced by any action in the first. Finally, the composition operator avoids requiring the application to explicitly take the result from the top-level ruleset and map it to a separate partial ruleset and initiate a separate matching operation in this second partial ruleset. Instead, this mapping occurs automatically as part of the rule evaluation.

In one embodiment, the ruleset composition operator eliminates a subcondition in a component rule if this subcondition duplicates the subcondition that is applied in every rule in the top-level ruleset that checks this. For example, if every top-level rule that has fish as its action has a subcondition of livesInWater, it is not necessary for the component fish partial ruleset to have this same subcondition.

In this hierarchical classification, it is possible for a top-level classification to misclassify into the wrong partial rule set because of coarser grain subconditions. For instance, there may be amphibians that appear much like fish. With these cases, the fish partial ruleset can include rules for these fish-like amphibians as well. Given there may be a small number of categories or species in this case that are subject to misclassification, the presence of these extra rules in the partial ruleset does not significantly detract from the benefits of this hierarchical structure/classification.

Logically, this composition is a “join” between the action designation in the first operand and the identifiers for the partial rulesets in the second operand. However, unlike an actual join, the paired rule conditions and partial rule sets are not actually materialized as a relation because that may entail duplicating the partial ruleset at each action in the first operand that references that partial ruleset.

In one embodiment, the ruleset composition operator optionally incorporates a referenced partial ruleset into the first operand ruleset by replicating and expanding the referencing rule for each rule in the referenced partial ruleset. That is, rather than having the rule evaluation continue in a component partial ruleset in all cases, the compilation of the top-level ruleset may follow the indirection to include all of the rules in the partial ruleset into the top-level ruleset before application execution is using this ruleset. As a simple example, if some actions in the first operand partial ruleset correspond to an error case which would otherwise be handled by a single rule component partial ruleset, the error action may be incorporated into the error rules in the first operand partial ruleset.

However, incorporating each second partial ruleset in its entirety by reference may mean the top-level ruleset would have to be rebuilt whenever any of the second-level rulesets are changed. It would also increase the size of the top-level ruleset (702) to the total of all partial rulesets and thus increase the cost of rule evaluation. Moreover, the second-level partial rulesets (704), (706), . . . , (712) may use a much more detailed set of subconditions to identify specific species than the top-level ruleset requires. For example, fish (704) may require a more detailed description of their water environment than a bird (710). Therefore, with this inclusion, the number of qualifiers per subcondition can end up being larger than the top-level or any one of the partial ruleset requires, further increasing the cost. In general, inclusion becomes equivalent to “inheriting” from each of the referenced partial rulesets with all the issues that (multiple) inheritance raises, including conflicting qualifiers between these inherited partial rulesets.

Specifying by reference rather than direct inclusion/value is a technique in software engineering to deal with high degrees of complexity by partitioning the details into one or more separate referenced entities. It is common in object-oriented programming to have a pointer to another object rather than directly including all the state of this other object. The ruleset composition operator, from a rule action to another partial ruleset, supports a comparable means for dealing with complexity but in the context of rulesets, separating a general classification or decision from a more specific one as well as allowing common partial rulesets to be separately represented, avoiding their duplication in the application ruleset.

Other Potential Ruleset Operations. Other ruleset operations may be used in the compiler of FIG. 4. For example, regarding the rule table of FIG. 6 as a matrix, there may be a vector-matrix multiply operation that multiplies the subconditions of each column by some scaling amount. However, a key focus herein is on operations that produce a more complete and thus more complex ruleset from simpler rulesets, thereby enabling the development of complex rulesets from simpler ones. A scaling operation and other similar operations, such as an analogous matrix multiplication or addition/subtraction may be useful in some applications, but may not increase the fundamental complexity of the result compared to the operand rulesets. Stated the other way around, the operand ruleset may not be clearly simpler or a reduced scope compared to the resulting ruleset.

A rule may also be regarded as a relation, mapping from the set of input scenarios to the set of actions. In this sense, ruleset operations are set operations on sets of relations. This view suggests considering the usual relation operators on rulesets as well. For instance, ruleset intersection may be regarded as similar to a “join” of relations defined by the rules in each ruleset, joined on their action sets. However, ruleset intersection may be interpreted as the cross-product of joins across the relations corresponding to the rules across all the operand rulesets.

The six basic operations in relational algebra are: Selection, Projection, Join, Union, Set Difference, and Cartesian Product. As shown above, ruleset versions of the last four of these operations have been described, with join corresponding to the intersection and composition operators. The remaining two, selection and projection, may also be provided in a ruleset version: Projection is removing one or more of the subconditions/columns of a ruleset table; and Selection returns a ruleset that is a subset of the rows of the operand ruleset table where the resulting rows/rules match some selection criteria on the subconditions and/or actions. In both cases, these operations are returning a simpler ruleset than the operand ruleset so may not produce more complex rulesets by ruleset operators from simpler ones, but may still be useful in some applications.

Note that a rule represents the members of the condition and action set as expressions that denote membership, rather than the specific members as a conventional relation indicates. It is generally not practical to list the specific members of the relation set, as done in a database. For example, the rule condition (temperature<100) may denote an unbounded number of scenarios as may the action of increasing the heater. In this sense, a key aspect herein is working with expressions at the level of rule condition, identified subcondition, and rule action, rather than at the level of actual members of a relation corresponding to a rule.

Therefore, the focus herein is on decomposing the rule specification into rule condition and rule action, and then into identified subconditions and subactions, and then into identified qualified subconditions and subactions. So, for instance, ruleset intersection is actually the intersection of intersections of the relation specified by each rule. Furthermore, each identified subcondition specifies a set as well. Therefore, the ruleset intersection is actually the intersection of the relation specified by each rule which is itself an intersection of the relations specified by the subconditions and actions. In this sense, how to practically employ set operations on rulesets to automatically compile complex rulesets from simpler ones is taught herein, which would not be practical by materializing a rule set to a relation with all the actual scenarios and actions that each rule may represent.

In one embodiment, a ruleset composition operator applies to rule conditions, that is, to allow a partial rule to reference another rule in order to have the rule condition of this other rule incorporated into the condition of this referencing rule. For instance, a subcondition may be a reference to another rule. For example, a partial rule can specify a decision result as clearedForTakeoff. Another rule may reference this action as a condition before deciding to take-off. This other rule is then treated as including the clearedForTakeoff rule condition as part of its rule condition, that is, to reference a rule condition in another partial rule and then have that rule condition included in its entirety in the referencing rule.

However, if not included by reference, this capability may lead to switching between rulesets as part of each rule evaluation. If included by reference, there is the potential complication of the referenced rule conditions conflicting with those in the referencing rule. Without such conflicts, the reference may be equivalent to a qualifier that references the corresponding expression that is the referenced rule condition. Moreover, it would be hard to understand a ruleset whose rules had ad hoc references in their rule conditions to other rules. Therefore, it is preferable to use ruleset-level operations on conditions and not support a general referential inclusion mechanism in the individual rule conditions.

For example, ruleset intersection provides the structure of having each partial ruleset represent a different aspect that has semantic meaning for the generated ruleset. Ruleset intersection already has well-defined handling of rule condition conflicts. Note that unlike traditional approaches including rules that modify “facts” that are then used in individual rules, these points emphasize a key aspect herein, namely the importance of treating a ruleset as a unit and avoiding ad hoc aspects on individual rule conditions.

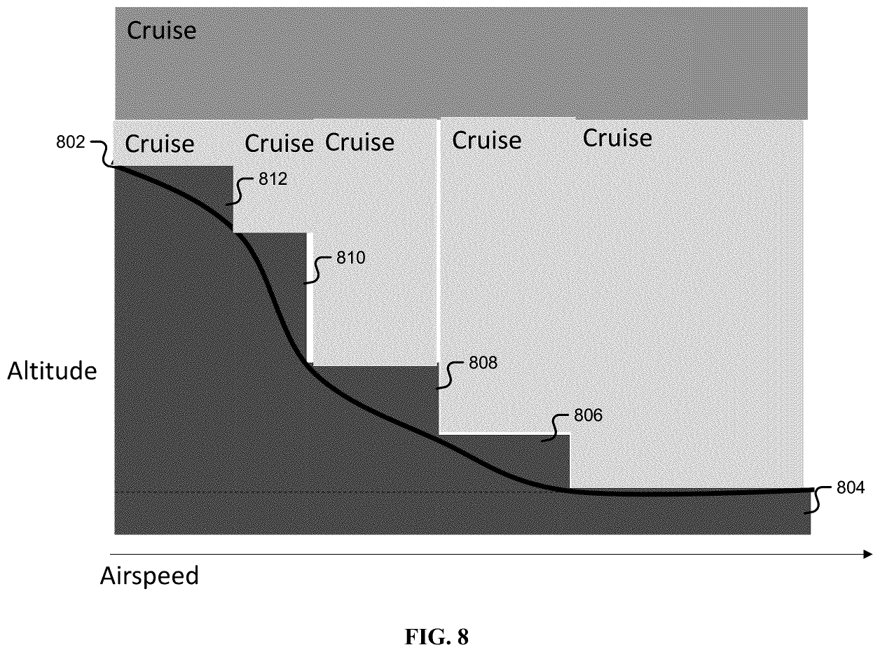

Automatically-Generated Partial Rules. In one embodiment, a partial rule set may be automatically generated by a computation. FIG. 8 is an illustration of the result of automatically computing a discretized partial ruleset for the trade-off between air-speed and altitude. As shown in FIG. 8, a partial rule set for airspeed versus altitude for a given maneuver may be computed based on the design of the aircraft. Here, the curved line (802) represents a continuous equation as typically arises in engineering the aircraft, and thus available to this computation as an equation. The vertical bars (804), (806), (808), (810), (812) represent qualifiers that discretize and approximate this curve based on the acceptable error relative to the curve line. Given the equation for the curved line and acceptable error, a program may compute these qualifiers and the associated rule conditions in terms of subconditions on the airspeed and altitude to ensure that the rule condition is true when the values are above the line in this case.

Automatic generation is feasible in this case because the partial ruleset is simple relative to the full application ruleset. The ruleset expressions herein allow the application ruleset to be automatically computed from partial rulesets such as this simplified one.

As another example, simulation of an engineered system together with an objective function may be used to generate the partial rule set, as described in U.S. patent application Ser. No. 17/156,378 entitled AUTOMATIC GENERATION OF CONTROL DECISION LOGIC FOR COMPLEX ENGINEERED SYSTEMS FROM DYNAMIC PHYSICAL MODEL which is incorporated herein by reference for all purposes. As another example, a partial ruleset may be generated by a separate collection of partial rule sets, subordinate to this partial rule set.

As another example, the rulesets used as operands to the Cartesian product used to check coverage may be automatically generated from the definition of each identified subcondition in a table. That is, the compiler can generate a ruleset for each identified subcondition, where each such ruleset contains a rule for each rule qualifier RQ to the action unknown, as described above.

In one embodiment, the compiler may be instructed to check rules coverage and then automatically generate the required Cartesian product ruleset and then take the ruleset difference with the specified rules to determine if there are missing cases in the coverage. If there are rules in the ruleset difference, these rules also indicate by their rule conditions, the set of scenarios that are not handled by the current application rules. The current application rules may have been generated by a separate set of partial rule sets as described above or by direct specification of application rules or a combination of these two approaches.

The presence of these uncovered rules above may be used to prompt the developer to refine these earlier partial rule sets so that the set of set-theoretic difference rules is empty, or at least reduced. Alternatively, the application ruleset may be extended by taking the union with this relative complement unknown action partial rule set, effectively adding these unknown rules into the application rule set. Then, the system that the rules control may be programmed to take an application-appropriate action on the rule action being unknown. In either case, the result is that the application ruleset is complete in that it produces an action on every possible scenario and that action is one that the controlled system is prepared to handle.

Optimizations. The compilation of a ruleset expression in terms of the operators provided for rulesets can provide for various optimizations, as is typical for a compiler to provide.

For one, each of the resulting (partial) rulesets may be compiled into a decision tree for faster evaluation possibly using a traditional technique such as “RBDT-1: a New Rule-based Decision Tree Generation Technique” by Abdelhalim, Traore, and Sayed. Then, rule evaluation cost is proportional to the number of subconditions, not the number of rows in the rule table. This approach is most straight-forward if the rulesets are unambiguous, that is a single rule match for each possible input combination.

For another, internally, the ruleset expression may be translated from a hierarchical computation into one that is a streaming computation. For instance, in one embodiment, the ruleset evaluation may produce individual rules from a ruleset operator that is providing its results to another ruleset operator, thereby avoiding having to completely generate and store the intermediate ruleset before processing the operator to which this is an operand. For example, an application ruleset may be derived from a partial ruleset that is specified as the intersection of K partial rulesets. As the intersection is performed, each resulting rule from the intersection is provided to the generating operator of the derived ruleset. A pre-specified rule may override the use of this rule from the base rule set. As a consequence, if a significant number of these intersection rules are overridden, the compiler may not actually store many of the intersection-generated rules because many of these are overridden and thus discarded before the next one is generated. Moreover, the ones that are retained are directly stored into the application ruleset, avoiding copying from an intersection ruleset as an intermediate result to the final output ruleset. This predefined ruleset used as above can be regarded as supported by using a form of the so-called x=operators as used in C++, wherein x is an operator. A ruleset may be refined by union as:

resultRuleset union=(intersection(A,B,C))

where A, B and c are partial rulesets and the resultRuleSet has one or more previously defined rules. Thus, the result of the intersection of these partial rulesets is unioned into the previously defined rules to form the result ruleset.

A similar optimization may be applied by the ruleset compiler in the coverage computation above. Rather than fully producing the required Cartesian product ruleset, the operator produces a rule at a time, which is then tested against the top-level ruleset to determine if already covered in that top-level ruleset and then discarded if so, and else added to this top-level ruleset. Then, coverage may be determined by a selection on the resulting ruleset with the selection criteria being the action of a rule being unknown. If the selection is non-empty, there is lack of coverage, specifically indicated by the rule conditions of the rules returned by the selection. In this case, the Cartesian product and the set difference rulesets are not fully instantiated, saving on space and copying.

Benefits. Partial ruleset operations herein and the resulting expressions support the normal divide-and-conquer strategy or modularity strategy used in automation systems to deal with complexity, but applied to rulesets. In particular, it is simpler to specify a partial ruleset for each aspect of the decision making rather than specifying manually in one combined ruleset specification. This separating out different aspects also facilitates inspection by an expert in some aspect at the level of partial result set. That is, the expert may just focus on the correctness and completeness of the partial ruleset that handles the aspect that this person is an expert on, rather than requiring them to look at the application ruleset, which has many other aspects factored in. For example, if one aspect in the decision making is regulatory, the expert on regulation need only examine the partial rule set associated with regulatory rules. Moreover, that partial rule set may be in the form of prohibitive rules, if that is the normal representation.

The compiler then converts it to an application ruleset constructive form automatically, as described earlier by the complement ruleset operation. Furthermore, the subconditions in a partial rule set may reflect the limits or qualifiers associated with this aspect. The compilation of the application rules from that partial rule set may handle restrictions on these qualifiers that may arise from other aspects, represented by other partial rulesets. Finally, separating out one aspect may allow the associated partial ruleset to be auto-generated even though it is not feasible to auto-generate the full application ruleset. Similar benefits apply to supporting the composition operator and component rulesets. Moreover, component rulesets support developing, storing, and processing the component rulesets separately from the top-level ruleset, further allowing hierarchical classification and common ruleset identification, similar to the common subexpression elimination optimization that is present in many conventional compilers.

Thus, the definition and use of the ruleset operations of intersection, union, complement, difference, and Cartesian product as well as indirect references applied to the specific semantics of rules to allow the automatic computation of rules from simpler and/or partial or more basic or general rule sets are described herein.

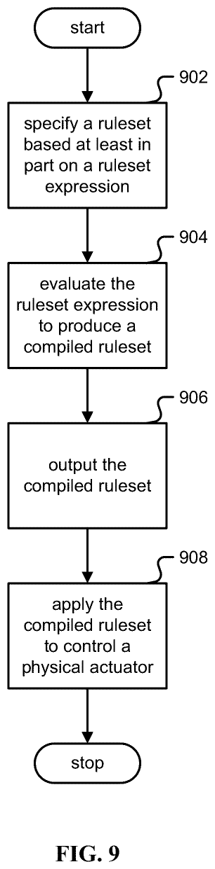

FIG. 9 is a flow diagram illustrating an embodiment of a process for automated generation of a ruleset and control. In one embodiment, the process of FIG. 9 is carried out by the system of FIG. 1.

In step (902), a ruleset is specified based at least in part on a ruleset expression that comprises one or more ruleset operations whose operands include partial rulesets. In one embodiment, the one or more ruleset operations are at least one of: a ruleset intersection, a ruleset union, a ruleset complement, a ruleset difference, a ruleset Cartesian product, and a ruleset composition. In one embodiment, a partial ruleset corresponds to a different aspect of the rule condition.

In step (904), the ruleset expression is evaluated to produce a compiled ruleset. In one embodiment, a rule condition is automatically generated from partial rules by performing set operations using partial rule conditions of the applicable partial rules, wherein the partial rule conditions are treated as a set membership. In one embodiment, a rule condition is expressed as a conjunction of subconditions. In one embodiment, a rule condition is identified. In one embodiment, a rule condition is identified and qualified. In one embodiment, a rule subcondition qualifier corresponds to a range of some input value and thus evaluates to true if and only if the relevant value is within the specified range. In step (906), the compiled ruleset is output.

In one embodiment, in the event an operation is an intersection with a plurality of partial rule sets, the ruleset intersection is computed at least in part by: selecting a rule from the plurality of partial rule sets relevant to an action designation that forms a previously unselected combination; computing with these selected partial rules to produce a generated rule; and outputting the generated rule.

In step (908) the compiled ruleset is applied to control a physical actuator. In one embodiment, the compiled ruleset is applied periodically with a minimum period of 50 milliseconds.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a physical actuator;
a compiler configured to:
specify a ruleset based at least in part on a ruleset expression that comprises one or more ruleset operations whose operands include partial rulesets;
evaluate the ruleset expression to produce a compiled ruleset; and
output the compiled ruleset; and
a processor coupled to the compiler and the physical actuator, wherein the processor is to configured to apply the outputted compiled ruleset to control the physical actuator.

2. The system of claim 1, wherein the processor is further configured to apply the outputted compiled ruleset periodically with a minimum period of 50 milliseconds.

3. The system of claim 1, wherein one of the one or more ruleset operations is at least one of: a ruleset intersection, a ruleset union, a ruleset complement, a ruleset difference, a ruleset Cartesian product, and a ruleset composition.

4. The system of claim 1, wherein a rule condition is automatically generated from partial rules by performing set operations using partial rule conditions of applicable partial rules, wherein the partial rule conditions are treated as a set membership.

5. The system of claim 1, wherein a rule condition is expressed as a conjunction of subconditions.

6. The system of claim 5, wherein at least one of the rule subconditions is identified.

7. The system of claim 6, wherein at least one of the rule subconditions is identified and qualified.

8. The system of claim 7, wherein a rule subcondition qualifier corresponds to a range of some input value and thus evaluates to true if and only if a relevant value is within a specified range.

9. The system of claim 1, wherein a partial ruleset corresponds to a different aspect of a rule condition.

10. The system of claim 1, wherein in the event an operation is in intersection with a plurality of partial rule sets, the ruleset intersection is computed at least in part by:
selecting a rule from the plurality of partial rule sets relevant to an action designation that forms a previously unselected combination;
computing with these selected partial rules to produce a generated rule; and
outputting the generated rule.

11. A method of controlling a system, comprising:
specifying a ruleset based at least in part on a ruleset expression that comprises one or more ruleset operations whose operands include partial rulesets;
evaluating the ruleset expression to produce a compiled ruleset;
outputting the compiled ruleset; and
applying the outputted compiled ruleset to control a physical actuator.

12. The method of claim 11, wherein a rule condition is expressed as a conjunction of subconditions.

13. The method of claim 12, wherein at least one of the rule subconditions is identified.

14. The method of claim 13, wherein at least one of the rule subconditions is identified and qualified.

15. The method of claim 14, wherein a rule subcondition qualifier corresponds to a range of some input value and thus evaluates to true if and only if a relevant value is within a specified range.

16. The method of claim 11, wherein one of the one or more ruleset operations is at least one of: a ruleset intersection, a ruleset union, a ruleset complement, a ruleset difference, a ruleset Cartesian product, and a ruleset composition.

17. The method of claim 11, wherein a rule condition is automatically generated from partial rules by performing set operations using partial rule conditions of applicable partial rules, wherein the partial rule conditions are treated as a set membership.

18. The method of claim 11, wherein a rule condition is expressed as a conjunction of subconditions.

19. The method of claim 11, wherein in the event an operation is in intersection with a plurality of partial rule sets, the ruleset intersection is computed at least in part by:
selecting a rule from the plurality of partial rule sets relevant to an action designation that forms a previously unselected combination;
computing with these selected partial rules to produce a generated rule; and
outputting the generated rule.

20. A computer program product embodied in a non-transitory computer readable medium and comprising computer instructions for:
specifying a ruleset based at least in part on a ruleset expression that comprises one or more ruleset operations whose operands include partial rulesets;
evaluating the ruleset expression to produce a compiled ruleset;
outputting the compiled ruleset; and
applying the outputted compiled ruleset to control a physical actuator.

21. The computer program product of claim 21, wherein a rule condition is expressed as a conjunction of subconditions.

22. The computer program product of claim 22, wherein at least one of the rule subconditions identified.

23. The computer program product of claim 23, wherein at least one of the rule subconditions is identified and qualified.

24. The computer program product of claim 24, wherein a rule subcondition qualifier corresponds to a range of some input value and thus evaluates to true if and only if a relevant value is within a specified range.

25. The computer program product of claim 21, wherein one of the one or more ruleset operations is at least one of: a ruleset intersection, a ruleset union, a ruleset complement, a ruleset difference, a ruleset Cartesian product, and a ruleset composition.

26. The computer program product of claim 21, wherein in the event an operation is in intersection with a plurality of partial rule sets, the ruleset intersection is computed at least in part by:
selecting a rule from the plurality of partial rule sets relevant to an action designation that forms a previously unselected combination;
computing with these selected partial rules to produce a generated rule; and
outputting the generated rule.
